(19) United States
(12) Patent Application Publication
(10) Pub. No.: US 2007/0122308 A1
(43) Pub. Date: May 31, 2007

(54) Biosensor

(75) Inventors: Morihito Ikeda, Kanagawa (JP); Taisei Nishimi, Kanagawa (JP); Hirohiko Tsuzuki, Kanagawa (JP); Toshihide Ezoe, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/604,698

(22) Filed: Nov. 28, 2006

(30) Foreign Application Priority Data
Nov. 28, 2005 (JP) 2005-341452

(51) Int. Cl. G01N 31/22

(52) U.S. Cl. 422/57

(57) ABSTRACT

An object of the present invention is to provide a biosensor having high capability for suppressing nonspecific protein adsorption and high capability for extracting a target protein. The present invention provides a biosensor which comprises a flow channel that is formed on a substrate and is composed of a detection plane for detecting interaction between a physiologically active substance and a test substance and a non-detection plane where said interaction is not detected, wherein the substrate is a metal surface or a metal film and the surfaces of the detection plane and the non-detection plane are modified with a self-assembled monolayer (SAM) having a hydroxy group and a functional group for binding with a physiologically active substance.

### TECHNICAL FIELD

The present invention relates to a biosensor and a method that involves analyzing interaction between biomolecules using the same and collecting substances that interact each other. The present invention particularly relates to a biosensor for use in a surface plasmon resonance biosensor and a method that involves analyzing interaction between biomolecules using the same and collecting substances that interact each other.

### BACKGROUND ART

Recently, a large number of measurements using intermolecular interactions such as immune responses are being carried out in clinical tests, etc. However, since conventional methods require complicated operations or labeling substances, several techniques are used that are capable of detecting the change in the binding amount of a test substance with high sensitivity without using such labeling substances. Examples of such a technique may include a surface plasmon resonance (SPR) measurement technique, a quartz crystal microbalance (QCM) measurement technique, and a measurement technique of using functional surfaces ranging from gold colloid particles to ultra-fine particles. The SPR measurement technique is a method of measuring changes in the refractive index near an organic functional film attached to the metal film of a chip by measuring a peak shift in the wavelength of reflected light, or changes in amounts of reflected light in a certain wavelength, so as to detect adsorption and desorption occurring near the surface. The QCM measurement technique is a technique of detecting adsorbed or desorbed mass at the ng level, using a change in frequency of a crystal due to adsorption or desorption of a substance on gold electrodes of a quartz crystal (device). In addition, the ultra-fine particle surface (nm level) of gold is functionalized, and physiologically active substances are immobilized thereon. Thus, a reaction to recognize specificity among physiologically active substances is carried out, thereby detecting a substance associated with a living organism from sedimentation of gold fine particles or sequences.

In all of the above-described techniques, the surface where a physiologically active substance is immobilized is important. Surface plasmon resonance (SPR), which is most commonly used in this technical field, will be described below as an example.

A commonly used measurement chip comprises a transparent substrate (e.g., glass), an evaporated metal film, and a thin film having thereon a functional group capable of immobilizing a physiologically active substance. The measurement chip immobilizes the physiologically active substance on the metal surface via the functional group. A specific binding reaction between the physiological active substance and a test substance is measured, so as to analyze an interaction between biomolecules.

As a thin film having a functional group capable of immobilizing a physiologically active substance, there has been reported a measurement chip where a physiologically active substance is immobilized by using a functional group binding to metal, a linker with a chain length of 10 or more atoms, and a compound having a functional group capable of binding to the physiologically active substance (Japanese Patent No. 2815120). Moreover, a measurement chip comprising a metal film and a plasma-polymerized film formed on the metal film has been reported (Japanese Patent Laid-Open No. 9-264843).

With the use of a biosensor, the presence or the absence of a protein that specifically binds to a specific substance (e.g., a peptide, a protein, or a drug) or the amount of the bound protein can be measured, and then any protein can be collected from a biological sample. However, methods that have been conventionally employed are problematic in terms of nonspecific adsorption to flow channel surfaces, low collection efficiency of high-molecular-weight proteins, and the like. Hence, such conventional methods are insufficient in terms of capability for collecting proteins and capability for suppressing contamination of nonspecific proteins. Techniques that have been employed to overcome these problems include a technique whereby a self-assembled monolayer (SAM) is used for surface modification of a detection plane and a technique whereby a flow channel surface is modified. However, the problems still have not been sufficiently addressed.

### DISCLOSURE OF INVENTION

It is an object of the present invention to solve the aforementioned problem. That is to say, an object of the present invention is to provide a biosensor having high capability for suppressing nonspecific protein adsorption and high capability for extracting a target protein.

As a result of intensive studies to achieve the above object, the present inventors have found that a biosensor having high capability for suppressing nonspecific protein adsorption and high capability for extracting a target protein can be provided by modifying the surfaces of a detection plane and a non-detection plane of a flow channel with a self-assembled monolayer (SAM). Thus, the present inventors have completed the present invention.

The present invention provides a biosensor which comprises a flow channel that is formed on a substrate and is composed of a detection plane for detecting interaction between a physiologically active substance and a test substance and a non-detection plane where said interaction is not detected, wherein the substrate is a metal surface or a metal film and the surfaces of the detection plane and the non-detection plane are modified with a self-assembled monolayer (SAM) having a hydroxy group and a functional group for binding with a physiologically active substance.

Preferably, the self-assembled monolayer (SAM) having a hydroxy group and a functional group for binding with a physiologically active substance is composed of a mixture of a thiol compound having a hydroxy group and a thiol compound having a functional group for binding with a physiologically active substance.

Preferably, the functional group for binding with a physiologically active substance is a carboxyl group or an amino group.

Preferably, the biosensor according to the present invention further comprises a mechanism for collecting a substance that interacts with a physiologically active substance.

Preferably, the metal surface or the metal film comprises a free electron metal selected from the group consisting of gold, silver, copper, platinum, and aluminium.

Preferably, the biosensor according to the present invention is used for non-electrochemical detection, and is more preferably used for surface plasmon resonance analysis.

Another aspect of the present invention provides a method for producing the aforementioned biosensor according to the present invention, which comprises a step of modifying the surfaces of the detection plane and the non-detection plane of the flow channel with a self-assembled monolayer (SAM) having a hydroxy group and a functional group capable of binding with a physiologically active substance.

Preferably in the aforementioned method, the self-assembled monolayer (SAM) having a hydroxy group and a functional group for binding with a physiologically active substance is composed of a mixture of a thiol compound having a hydroxy group and a thiol compound having a functional group for binding with a physiologically active substance.

Preferably in the aforementioned method, the functional group for binding with a physiologically active substance is a carboxyl group or an amino group.

Further another aspect of the present invention provides a method for detecting or measuring a substance that interacts with a physiologically active substance, which comprises steps of: causing the aforementioned biosensor according to the present invention to come into contact with a physiologically active substance, so as to covalently bind the physiologically active substance to the surfaces of a detection plane and a non-detection plane of the flow channel of the biosensor; and causing a test substance to come into contact with the biosensor wherein the physiologically active substance is covalently bound to the surfaces of the detection plane and the non-detection plane of the flow channel.

Preferably, the step of binding the physiologically active substance to the biosensor and the step of causing the test substance to come into contact with the biosensor so as to detect or measure a substance that interacts with the physiologically active substance are performed using different apparatuses.

Further another aspect of the present invention provides a method for producing a biosensor and detecting or measuring a substance that interacts with a physiologically active substance, wherein the following steps are continuously performed with one apparatus: a step of performing the aforementioned method for producing the biosensor according to the present invention; a step of causing the biosensor produced in said step to come into contact with a physiologically active substance, so as to covalently bind the physiologically active substance to the surfaces of a detection plane and a non-detection plane of a flow channel of the biosensor; and a step of causing a test substance to come into contact with the biosensor wherein the physiologically active substance is covalently bound to the surfaces of the detection plane and the non-detection plane of the flow channel.

Preferably, a substance that interacts with a physiologically active substance is detected or measured by a non-electrochemical method, and is more preferably detected or measured by surface plasmon resonance analysis.

Further another aspect of the present invention provides a method for analyzing a substance that interacts with a physiologically active substance, which comprises detecting and collecting a substance that interacts with a physiologically active substance with the use of the biosensor according to the present invention and determining the mass number of the collected substance using a mass spectrometer.

### BRIEF DESCRIPTION OF THE DRAWINGS

FIG. 1 shows a comparison of values representing binding activity concerning various films.

FIG. 2 shows examples of the flow channel of the present invention.

### BEST MODE FOR CARRYING OUT THE INVENTION

The embodiments of the present invention will be described below.

The biosensor of the present invention comprises a substrate and a flow channel that is formed on the substrate. The biosensor of the present invention has as broad a meaning as possible, and the term biosensor is used herein to mean a sensor, which converts an interaction between biomolecules into a signal such as an electric signal, so as to measure or detect a target substance. The conventional biosensor is comprised of a receptor site for recognizing a chemical substance as a detection target and a transducer site for converting a physical change or chemical change generated at the site into an electric signal. In a living body, there exist substances having an affinity with each other, such as enzyme/substrate, enzyme/coenzyme, antigen/antibody, or hormone/receptor. The biosensor operates on the principle that a substance having an affinity with another substance, as described above, is immobilized on a substrate to be used as a molecule-recognizing substance, so that the corresponding substance can be selectively measured.

The structure of a “flow channel” in the present invention is not particularly limited, as long as it is formed on a substrate so that a fluid can flow. The flow channel in the present invention is composed of a detection plane for detecting interaction between a physiologically active substance and a test substance and a non-detection plane where the interaction is not detected. Furthermore, the shape of the cross section of the flow channel is not particularly limited, and may be any shape such as a square, a rectangle, a trapezoid, a circle, a semicircle, an ellipse, or the like.

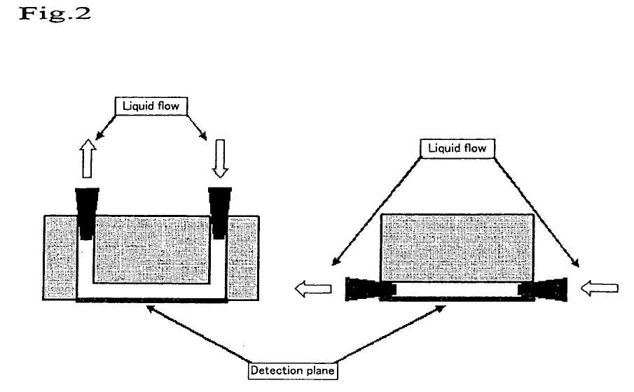

The flow channel in the present invention does no contain syringes and pipettes for injection of medicines or proteins. In view of prevention of contamination, a medicine or a protein is preferably injected using a disposable pipette. FIG. 2 shows an example of the flow channel of the present invention.

The flow channel in the left figure in FIG. 2 is formed of three regions: a region for fluid injection; a region including a detection plane; and a region for fluid discharge. The region for fluid injection and the region for fluid discharge are formed and positioned almost perpendicular to the region including the detection plane. In the case of the left figure in FIG. 2, all inner surfaces within the region for fluid injection and the region for fluid discharge of the flow channel function as non-detection planes. Within the region containing a detection plane, the bottom surface of the flow channel functions as the detection plane, and the side and the top surfaces of the flow channel function as non-detection planes.

Furthermore, in the right figure in FIG. 2, a flow channel is formed in a straight line. In this case, the bottom surface of the flow channel functions as a detection plane, and the side and the top surfaces of the flow channel function as non-detection planes.

Examples of flow channel members to be used in the present invention include, but are not particularly limited to, polydimethyl siloxane, polypropylene, polyethylene, polymethylmethacrylate, and polystyrene. “Detection plane” in this specification means, among the inner surfaces of a flow channel, a surface on which interaction between a physiologically active substance and a test substance is detected. Moreover, “non-detection plane” in this specification means, among the inner surfaces of the flow channel, a surface on which the interaction as described above is not detected.

Preferably, the biosensor of the present invention can be further provided with a mechanism for collecting a substance that interacts with a physiologically active substance. As such a mechanism, a pipette or the like can be used.

In the present invention, all surfaces of the above-described detection plane and non-detection plane are modified with a self-assembled monolayer (SAM), so that a physiologically active substance can be immobilized. “Self-assembled monolayer (SAM)” in the present invention refers to an ultrathin film such as a monomolecular film or an LB film, which is characterized by a structure that is well-ordered in a fixed manner and is formed by the film material's own mechanism without any fine external control. Because of such self assembly, structures or patterns that are well-ordered over long distances are formed under nonequilibrium conditions.

Sulfur-containing compounds such as thiols and disulfides are spontaneously adsorbed onto a noble metal substrate such as gold, resulting in the formation of a monomolecular-sized ultrathin film. The thus ordered assembly is characterized by a sequence the formation of which depends on the crystal lattice of the substrate or the molecular structure of an adsorption molecule. Thus, the assembly is referred to as “self-assembled monolayer (SAM).”

For example, a self-assembled monolayer (SAM) can be formed using a sulfur-containing compound. Formation of such a self-assembled monolayer (SAM) using a sulfur-containing compound on a gold surface is described in: Nuzzo RG et al., (1983), J Am Chem Soc, vol. 105, pp. 4481 to 4483; Porter M D et al., (1987), J Am Chem Soc, vol. 109, pp.3559 to 3568; and Troughton EB et al., (1988), Langmuir, vol. 4, pp.365 to 385, for example.

As a molecule composing a self-assembled monolayer (SAM), a compound represented by X¹—R¹—Y¹ can be used. X¹-R¹-Y¹ will be described as follows.

X¹ is a group capable of binding to a metal film. Specifically, asymmetric or symmetric sulfide (—SSR¹¹Y¹¹ or —SSR¹Y¹), sulfide (—SR¹¹Y¹¹ or —SR¹Y¹), diselenide (—SeSeR¹¹Y¹¹ or —SeSeR¹Y¹), selenide (SeR¹¹Y¹¹ or —SeR¹Y¹), thiol (—SH), nitrile (—CN), isonitrile, nitro (—NO₂), selenol (—SeH), trivalent phosphorus compound, isothiocyanate, xanthate, thiocarbamate, phosphine, and thio acid or dithioic acid (—COSH or —CSSH) are preferably used.

R¹ and R¹¹, which are interrupted by heteroatoms in some cases, are preferably straight (unbranched) chains for appropriate dense packing or hydrocarbon chains containing double and/or triple bonds in some cases. The chain length is preferably longer than 10 atoms. A carbon chain can be perfluorinated in some cases.

Y¹ and Y¹¹ are functional groups for binding with physiologically active substances. Y¹ and Y¹¹ are preferably identical to each other and have the property of being capable to bind to physiologically active substances directly or after activation. Specifically, a hydroxyl, a carboxyl, an amino, an aldehyde, a hydrazide, a carbonyl, an epoxy, a vinyl group, or the like can be used.

Specific examples of such organic molecule X¹—R¹—Y¹ include 10-carboxy-1-decanethiol, 4,4′-dithiodibutyric acid, 11-hydroxy-1-undecanethiol, 11-amino-1-undecanethiol, 7-carboxy-1-heptanethiol, and 16-mercaptohexadecanoic acid.

In the present invention, a self-assembled monolayer (SAM) having a hydroxy group and a functional group for binding with a physiologically active substance is used. Preferably, a mixture of a thiol compound having a hydroxy group and a thiol compound having a functional group (e.g., the above-described carboxyl, amino, aldehyde, hydrazide, carbonyl, epoxy, or vinyl group) for binding with a physiologically active substance can be used.

In the present invention, the surfaces of a detection plane and a non-detection plane of a flow channel are modified as follows. For example, gold is deposited on the surfaces of the detection plane and the non-detection plane of the flow channel. A mixed solution (e.g., an ethanol solution) containing a thiol compound that has a hydroxy group and a thiol compound that has a functional group for binding with a physiologically active substance is caused to come into contact and to react with the above gold surfaces. Thus, a self-assembled monolayer (SAM) is formed on the gold surfaces.

The non-detection plane of the flow channel of the present invention may be modified in the same manner as or in a manner different from that used for the detection plane. Preferably, the detection plane and the non-detection plane are modified in the same manner.

In the biosensor of the present invention, a metal surface or metal film is preferably modified with self-assembled monolayer. A metal constituting the metal surface or metal film is not particularly limited, as long as surface plasmon resonance is generated when the metal is used for a surface plasmon resonance biosensor. Examples of a preferred metal may include free-electron metals such as gold, silver, copper, aluminum or platinum. Of these, gold is particularly preferable. These metals can be used singly or in combination. Moreover, considering adherability to the above substrate, an interstitial layer consisting of chrome or the like may be provided between the substrate and a metal layer.

The film thickness of a metal film is not limited. When the metal film is used for a surface plasmon resonance biosensor, the thickness is preferably between 0.1 nm and 500 nm, and particularly preferably between 1 nm and 200 nm. If the thickness exceeds 500 nm, the surface plasmon phenomenon of a medium cannot be sufficiently detected. Moreover, when an interstitial layer consisting of chrome or the like is provided, the thickness of the interstitial layer is preferably between 0.1 nm and 10 nm.

Formation of a metal film may be carried out by common methods, and examples of such a method may include sputtering method, evaporation method, ion plating method, electroplating method, and nonelectrolytic plating method.

A metal film is preferably placed on a substrate. The description “placed on a substrate” is used herein to mean a case where a metal film is placed on a substrate such that it directly comes into contact with the substrate, as well as a case where a metal film is placed via another layer without directly coming into contact with the substrate. When a substrate used in the present invention is used for a surface plasmon resonance biosensor, examples of such a substrate may include, generally, optical glasses such as BK7, and synthetic resins. More specifically, materials transparent to laser beams, such as polymethyl methacrylate, polyethylene terephthalate, polycarbonate or a cycloolefin polymer, can be used. For such a substrate, materials that are not anisotropic with regard to polarized light and have excellent workability are preferably used.

A physiologically active substance immobilized on the detection plane and the non-detection plane of the flow channel of the present invention is not particularly limited, as long as it interacts with a measurement target. Examples of such a substance may include an immune protein, an enzyme, a microorganism, nucleic acid, a low molecular weight organic compound, a nonimmune protein, an immunoglobulin-binding protein, a sugar-binding protein, a sugar chain recognizing sugar, fatty acid or fatty acid ester, and polypeptide or oligopeptide having a ligand-binding ability.

Examples of an immune protein may include an antibody whose antigen is a measurement target, and a hapten. Examples of such an antibody may include various immunoglobulins such as IgG, IgM, IgA, IgE or IgD. More specifically, when a measurement target is human serum albumin, an anti-human serum albumin antibody can be used as an antibody. When an antigen is an agricultural chemical, pesticide, methicillin-resistant Staphylococcus aureus, antibiotic, narcotic drug, cocaine, heroin, crack or the like, there can be used, for example, an anti-atrazine antibody, anti-kanamycin antibody, anti-metamphetamine antibody, or antibodies against 0 antigens 26, 86, 55, 111 and 157 among enteropathogenic Escherichia coli.

An enzyme used as a physiologically active substance herein is not particularly limited, as long as it exhibits an activity to a measurement target or substance metabolized from the measurement target. Various enzymes such as oxidoreductase, hydrolase, isomerase, lyase or synthetase can be used. More specifically, when a measurement target is glucose, glucose oxidase is used, and when a measurement target is cholesterol, cholesterol oxidase is used. Moreover, when a measurement target is an agricultural chemical, pesticide, methicillin-resistant Staphylococcus aureus, antibiotic, narcotic drug, cocaine, heroin, crack or the like, enzymes such as acetylcholine esterase, catecholamine esterase, noradrenalin esterase or dopamine esterase, which show a specific reaction with a substance metabolized from the above measurement target, can be used.

A microorganism used as a physiologically active substance herein is not particularly limited, and various microorganisms such as Escherichia coli can be used.

As nucleic acid, those complementarily hybridizing with nucleic acid as a measurement target can be used. Either DNA (including cDNA) or RNA can be used as nucleic acid. The type of DNA is not particularly limited, and any of native DNA, recombinant DNA produced by gene recombination and chemically synthesized DNA may be used.

As a low molecular weight organic compound, any given compound that can be synthesized by a common method of synthesizing an organic compound can be used.

A nonimmune protein used herein is not particularly limited, and examples of such a nonimmune protein may include avidin (streptoavidin), biotin, and a receptor.

Examples of an immunoglobulin-binding protein used herein may include protein A, protein G, and a rheumatoid factor (RF).

As a sugar-binding protein, for example, lectin is used.

Examples of fatty acid or fatty acid ester may include stearic acid, arachidic acid, behenic acid, ethyl stearate, ethyl arachidate, and ethyl behenate.

When a physiologically active substance is a protein such as an antibody or enzyme, or nucleic acid, an amino group, thiol group or the like of the physiologically active substance is covalently bound to a functional group located on a metal surface, so that the physiologically active substance can be immobilized on the metal surface.

A biosensor to which a physiologically active substance is immobilized as described above can be used to detect and/or measure a substance which interacts with the physiologically active substance.

Furthermore, a substance that interacts with a physiologically active substance bound to the surfaces of the detection plane and the non-detection plane of the flow channel can be collected.

Namely, the present invention provides a method for detecting and/or measuring and/or collecting a substance that interacts with a physiologically active substance, which comprises a step of bringing the biosensor according to the present invention having on its surface a physiologically active substance bound thereto into contact with a test substance.

As a test substance, a sample containing a substance interacting with the aforementioned physiologically active substance can be used, for example.

In the present invention, it is preferable to detect and/or measure an interaction between a physiologically active substance immobilized on the surface used for a biosensor and a test substance by a nonelectric chemical method. Examples of a non-electrochemical method may include a surface plasmon resonance (SPR) measurement technique, a quartz crystal microbalance (QCM) measurement technique, and a measurement technique that uses functional surfaces ranging from gold colloid particles to ultra-fine particles.

In a preferred embodiment of the present invention, the biosensor of the present invention can be used as a biosensor for surface plasmon resonance which is characterized in that it comprises a metal film placed on a transparent substrate.

A biosensor for surface plasmon resonance is a biosensor used for a surface plasmon resonance biosensor, meaning a member comprising a portion for transmitting and reflecting light emitted from the sensor and a portion for immobilizing a physiologically active substance. It may be fixed to the main body of the sensor or may be detachable.

When the biosensor of the present invention is used for surface plasmon resonance analysis, the biosensor can be used as a part of various surface plasmon resonance measuring apparatuses as described in paragraph Nos. 0041 to 0054 in JP Patent Publication (Kokai) No. 2004-271514 A.

Furthermore, according to the present invention, a biosensor can be produced and a substance that interacts with a physiologically active substance can be detected or measured by continuously performing, with the use of one apparatus, the steps of: implementing the method for producing a biosensor of the present invention as described above in this specification; causing the biosensor produced in such step to come into contact with a physiologically active substance, so as to covalently bind the physiologically active substance to the surfaces of the detection plane and the non-detection plane of a flow channel of the biosensor; and causing a test substance to come into contact with the biosensor where the physiologically active substance is covalently bound to the surfaces of the detection plane and the non-detection plane of the flow channel. Here the phrase “continuously performing, with the use of one apparatus,” means to continuously perform the procedure without changing the form of the flow channel. Specifically, this phrase means to modify (that is, to carry out modification with a self-assembled monolayer (SAM) having a hydroxy group and a functional group for binding with a physiologically active substance) the surface of the previously assembled flow channel and subsequently perform assay (that is, to cause the physiologically active substance to bind to the biosensor and then cause the test substance to come into contact with the biosensor, so as to detect or measure a substance that interacts with the physiologically active substance).

Furthermore, after detection and collection of a substance that interacts with a physiologically active substance with the use of the biosensor of the present invention, the mass number of the collected substance can be determined using a mass spectrometer. As a mass spectrometer, MALDI-TOF-MS (Matrix Assisted Laser Desorption/Ionization-Time of Flight-Mass Spectrometry), ESI-MS (Electrospray Ionization Mass Spectrometry), or the like can be used. Moreover, when the collected substance is protein, a protein that interacts with a physiologically active substance can also be detected and identified by digesting the protein with protease, obtaining the mass spectrometry spectrum of the peptide, and then identifying the spectrum through comparison with the mass spectrometry spectrum of a previously measured (known) protein or a mass spectrometry spectrum predicted from genome information.

The present invention will be further described in detail with reference to the following examples. However, the scope of the present invention is not limited by such examples.

### EXAMPLES

### Example 1

### Evaluation of the Protein Binding Capability of SAM-Coated Sensor Chip Surface

(1) Preparation of a SAM Solution

9.2 mg of 11-hydroxy-1-undecanethiol (produced by ALDRICH), 1.4 mg of 16-mercaptohexadecanoic acid (produced by ALDRICH), 2 ml of ultra pure water, and 8 ml of ethanol were sufficiently mixed at 40° C. and then used.

(2) SAM Coating

A gold-coated glass chip (Sensor Chip Au produced by Biacore) was treated using a Model-208UV-ozone cleaning system (TECHNOVISION INC.) for 12 minutes. The above SAM solution was caused to come into contact with the glass chip, followed by 1 hour of reaction at 40° C. Washing with ethanol was performed once and then washing with ultra pure water was performed once.

(3) Hydrophobic Polymer Coating

A film of polymethylmethacrylate-polystyrene copolymer (PMMA/PSt) (molar ratio of 50:50 and average molecular weight of 20,000) was formed with a film thickness of 20 nm on a gold-deposited surface according to the method described in JP Patent Application No. 2003-405704. Specifically, a gold block was treated with a Model-208UV-ozone cleaning system (TECHNOVISION INC) for 12 minutes. 0.2% PMMA/PSt was added dropwise onto the gold-deposited surface, and then spin coating was performed at 1,000 rpm for 45 seconds. Furthermore, under conditions described in JP Patent Application No.2003-405704 (specifically, performance of 16 hours of immersion in a NaOH aqueous solution (1 N) at 40° C., 3 instances of washing with water, and then removal of water through nitrogen blowing), hydrolysis was performed so that carboxylic acid was generated. The thus generated carboxylic acid surface was immersed for 60 minutes in a mixed solution of 1-ethyl-2,3-dimethylaminopropyl carbodiimide (400 nM) and N-hydroxysuccinimide (100 mM) and then immersed for 16 hours in a 5-aminovaleric acid (1 mol/l and adjusted at pH 8.5) solution, followed by washing with ultra-pure water.

(4) Evaluation of Adsorption to a SAM-Coated Surface

The amounts of analytes bound to ligands (Actin) immobilized on a SAM-coated sensor chip, a hydrophobic polymer-coated sensor chip, and a carboxydextran-coated sensor chip (Sensor Chip CM5 produced by Biacore) were measured using Biacore3000 (produced by Biacore).

(5) Preparation of Various Reagents

(i) Preparation of a ligand solution:

1 mg of muscle actin (produced by Cytoskeleton) was dissolved in 100 μl of ultra-pure water, and then 10 mg/ml stock (in 5 mM Tris-HCl buffer) was prepared. This stock was diluted with 10 mM acetate buffer (pH 4.5), thereby preparing 0.04 mg/ml solution.

(ii) Preparation of Activation Solutions:

The following solutions were mixed at a volume ratio of 1:1 immediately before use.
a. 0.1 M NHS solution and 0.4 M EDC solution (each produced by Biacore)
b. 0.1 M Sulfo-NHS solution (produced by PIERCE) and 0.4M EDC solution
   (iii) Blocking Solution:
a. 1 M ethanolamine solution (pH 8.5)
b. 1 M tetraethylene glycol amine (pH 9.0)
   (iv) Analyte solution:

Anti-actin mouse IgG (produced by Abcam Ltd) and anti-actin mouse IgM (produced by DBS) were each diluted 50-fold with HBS-P buffer (produced by Biacore). Anti GFP IgG (produced by Rockland) and BSA (produced by SIGMA) were each adjusted with HBS-P buffer to a concentration of 0.5 mg/ml. In addition, the HBS-P buffer was composed of 0.01 mol/I HEPES (N-2-hydroxyethylpiperazine-N′-2-ethanesulfonic acid) (pH 7.4), 0.15 mol/l NaCl, and surfactant P20 (0.005 % by weight).

(6) Ligand Immobilization

(i) Immobilization to the SAM-coated sensor chip and the hydrophobic polymer-coated sensor chip

This procedure was always performed using Biacore3000 (produced by Biacore). Each sensor chip was set in an apparatus and HBS-P buffer was caused to flow at a constant rate of 10 μl/min. The signal value at 3 minutes after the start of the flowing of the buffer was determined to be 0. The flowing of the activation solution “b” (Sulfo-NHS/EDC) was maintained for 30 minutes, and then the flowing of the ligand solution was maintained for 30 minutes. Furthermore, the flowing of a blocking agent “b” was maintained for 30 minutes. 10 mM Gly-HCl (pH 1.5) and 10 mM NaOH were each caused to flow for 1 minute. After washing, equilibration was further performed with HBS-P for 5 minutes. The thus obtained signal value was determined to be the amount of the immobilized ligand.

(ii) Immobilization to a CM5 Sensor Chip

This procedure was always performed using Biacore3000 (produced by Biacore). The sensor chip was set in an apparatus. HBS-P buffer was caused to flow at a constant rate of 10 μl/min. The signal value at 3 minutes after the start of the flowing of the buffer was determined to be 0. The flowing of the activation solution “a” (NHS/EDC) was maintained for 7 minutes, the flowing of the ligand solution was maintained for 7 minutes, and then the flowing of a blocking solution “a” was maintained for 7 minutes. 10 mM Gly-HCl (pH1.5) and 10 mM NaOH were each caused to flow for 1 minute. After washing, equilibration was performed with HBS-P for 5 minutes. The thus obtained signal value was determined to be the amount of the immobilized ligand.

(7) Measurement of the Amounts of Bound Analytes

The amount of each bound analyte was measured while each chip was set in an apparatus. HBS-P buffer was caused to flow at a constant rate of 10 μl/min. Measurement was begun under such conditions. The signal value at 3 minutes after the start of measurement was determined to be 0. 30 μl of each analyte solution was injected into a flow channel within 3 minutes. After injection, the solution was allowed to stand for 3 minutes. The signal value at 3 minutes after this time period was estimated to correspond to the amount of the bound analyte.

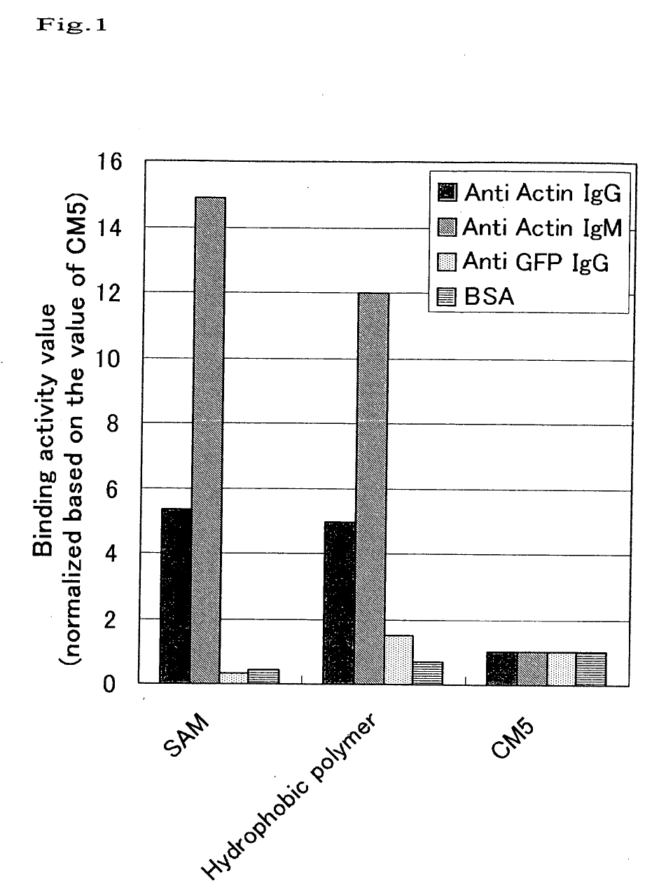

The amount of each bound analyte was estimated based on the number of moles of the analyte. The value was then divided by the number of moles of the ligand bound to the analyte. Thus, the number of analyte molecules that had bound per molecule of ligand was calculated. The thus calculated value was defined as a value representing binding activity. FIG. 1 lists the thus obtained various values representing binding activity that were normalized based on the value representing binding activity in the case of CM5. The amounts of the bound negative control analytes (anti-GFP IgG and BSA) were each normalized (the value representing binding activity in the case of CM5 was determined to be 1) based on the amount of bound analytes in the case of CM5.

(8) Evaluation of the Results

As shown in the results in FIG. 1, the SAM-coated surface used in the present invention is greatly superior to CM5 or the hydrophobic polymer-coated surface in terms of capability for binding with a specific binding substance (in FIG. 1, anti-actin IgG and IgM) and also in terms of capability for suppressing nonspecific adsorption (in FIG. 1, anti-GFP IgG and BSA). Thus, it was shown that the SAM-coated surface is appropriate for a biosensor for specific detection and extraction of a substance.

### Example 2

### Extraction of Specific Proteins using Flow Channel Where Entire Surface is Coated with SAM

(1) Deposition of Gold

A flow channel outer frame (Flow cell carrier type 2 produced by Biacore) was installed on a substrate holder of a sputtering apparatus. After vacuumization (base pressure of 1×10⁻³ Pa or less), Ar gas was introduced (1 Pa). RF power (0.5 kW) was applied to the substrate holder for approximately 9 minutes while rotating (20 rpm) the substrate holder, so that plasma treatment (also referred to as substrate etching or reverse sputtering) was performed for FET. Next, Ar gas introduction was stopped, vaccumization was performed, and then Ar gas was introduced again (0.5 Pa). DC power (0.2 kW) was applied to an 8-inch Cr target for approximately 30 seconds while rotating (10 rpm to 40 rpm) the substrate holder, thereby forming a 2-nm Cr thin film. Next, Ar gas introduction was stopped, vaccumization was performed again, and then Ar gas was introduced again (0.5 Pa). DC power (1 kW) was applied to an 8-inch Au target for approximately 50 seconds while rotating (20 rpm) the substrate holder, thereby forming an Au thin film of approximately 50 nm. The Au particle size was approximately 20 nm.

(2) SAM Coating of Entire Surface of Flow Channel

A flow channel (left figure in FIG. 2) was prepared with a combination of a gold-deposited flow channel outer frame (flow cell carrier) and a gold-coated glass chip. The thus prepared flow channel was caused to come into contact with an SAM solution (prepared by the same method as that of Example 1). After 1 hour of reaction at 40° C., the entire flow channel surface was washed with ethanol and ultra-pure water.

(3) Ligand Immobilization

Anti-mouse IgM or IgG (produced by Alpha Diagnostic International) was immobilized in each flow channel using the same technique as that of Example 1. IgG concentration employed upon immobilization was 0.1 mg/ml.

(4) Specific Protein Extraction from a Solution Containing Disrupted Cells

A flow channel prepared with a combination of a measurement surface with the flow channel of the present invention and a flow channel prepared with a combination of a measurement surface with an untreated flow channel were set in a Biacore3000 Surface Prep Unit. An experiment of collecting a specific protein from a solution containing disrupted cells was conducted.

(5) Preparation of a Solution Containing Disrupted Cells

Hela cells were washed with PBS and then pipetting was performed in a buffer containing 1% NP-40. The resultant was allowed to stand at room temperature for 15 minutes and then centrifuged at 1000 rpm for 2 minutes. The resulting supernatant was collected. The collected supernatant was then centrifuged at 15000 rpm for 30 minutes and then the supernatant was collected. Anti-actin mouse IgM (produced by DBS) was mixed with the thus collected solution to a final concentration of 0.05 mg/ml.

(6) Specific Protein Extraction from the Solution Containing Disrupted Cells

HBS-P buffer was caused to flow at a constant rate of 5 μl/min. Measurement was begun under such conditions. After 3 minutes of equilibration, the solution containing disrupted cells was caused to come into contact with the flow channel while causing the flowing of the solution for 3 minutes. The flowing of HBS-P buffer was maintained again for 10 minutes to perform washing. Subsequently, 50 mM NaOH aqueous solution was caused to come into contact with the flow channel for 20 seconds, followed by collection of the solution. Treatment (from contact to collection) of the solution containing disrupted cells was repeated 10 times. The thus obtained protein extract was separated by SDS-PAGE, and silver staining was performed to confirm the protein. SDS-PAGE was performed using gel and an electrophoresis system (produced by Bio-Rad) according to the recommended protocols thereof. Furthermore, silver staining was performed using a kit (produced by GE Healthcare) according to the recommended protocols thereof.

These procedures were performed for a flow channel, the entire surface of which, including the non-detection part, had been coated with SAM; a flow channel where only the detection plane is coated with SAM; and a flow channel where only the detection plane is coated with CM5. The results of observation of the obtained gel are listed in Table 1.

TABLE 1
Capability for extracting specific proteins
with the use of various films

| | IgM | Actin | Keratin |
|---|---|---|---|
| Entire surface is coated | A | A | C |
| with SAM | | | |
| Only the detection plane | B | B | B |
| is coated with SAM | | | |
| Only the detection plane | C | B | B |
| is coated with CM5 | | | |

A: Easily and visually detectable within 30 seconds in the silver staining procedure (developing).
B: Visually detectable within 5 minutes in the silver staining procedure (developing).
C: Impossible to detect any significant differences compared with the background even 5 minutes or more after the silver staining procedure (developing).

(7) Evaluation of the Results

As in the results in Table 1, it was demonstrated that the flow channel of the present invention, the surface of which had been entirely coated with SAM, has high capability for suppressing nonspecific adsorption of a protein such as keratin, compared with the comparative example. It was also demonstrated that the flow channel of the present invention has high capability for extracting target proteins. Thus, according to the present invention, a biosensor having excellent capability for extracting specific proteins could be provided.

### Example 3

### Specific Protein Extraction using Flow Channel Surfaces Entirely Coated with SAM

(1) Deposition

A prism made of polycycloolefin and a flow channel made of polypropylene (left figure in FIG. 2) were installed on a substrate holder of a sputtering apparatus. Ar gas (1 Pa) was introduced after vaccumization (base pressure of 1×10⁻³Pa or less). RF power (0.5 kW) was applied to the substrate holder for approximately 9 minutes while the substrate holder was rotated (20 rpm). Thus, plasma treatment (also referred to as substrate etching or reverse sputtering) was performed for FET. Next, Ar gas introduction was stopped, vaccumization was performed, and then Ar gas was introduced again (0.5 Pa). DC power (0.2 kW) was applied to an 8-inch Cr target for approximately 30 seconds while the substrate holder was rotated (10 rpm to 40 rpm), thereby forming a 2-nm Cr thin film. Next, Ar gas introduction was stopped, vaccumization was performed again, and then Ar gas was introduced again (0.5 Pa). DC power (1 kW) was applied to an 8-inch Au target for approximately 50 seconds while the substrate holder was rotated (20 rpm), thereby forming an Au thin film of approximately 50 nm. The Au particle size was approximately 20 nm.

(2) SAM Coating

A SAM solution (prepared by the same method as in Example 1) was caused to come into contact with the surface of a gold-deposited prism (made of polycycloolefin) and the surface of a flow channel (made of polypropylene). After 1 hour of reaction at 40° C., washing was performed with ethanol and ultra pure water.

(3) Ligand Immobilization

The chips were each set in an apparatus and then the flow channel was filled with HBS-P buffer. 100 μl of an activation solution (prepared by the same technique as that employed for the activation agent “b” in Example 1) was injected into the flow channel within 1 second and then the flow channel was allowed to stand for 30 minutes. Subsequently, 100 μl of HBS-P buffer was injected into the flow channel within 1 second and then 100 μl of a ligand solution (prepared by the same technique as that of Example 2) was injected into the flow channel within 1 second. The flow channel was allowed to stand for 30 minutes. Subsequently, 100 μl of HBS-P buffer was injected into the flow channel within 1 second and then 100 μl of a blocking solution (prepared by the same technique as that employed for the blocking agent “b” in Example 1) was injected into the flow channel within 1 second. The flow channel was allowed to stand for 30 minutes. Subsequently, 1 second of injection of 100 μl of HBS-P buffer into the flow channel and a following 1 second of injection of 100 μl of a 10 mM NaOH solution into the flow channel were repeated twice in sequence. Furthermore, the flow channel was allowed to stand for 30 seconds after substitution with HBS-P.

(4) Specific Protein Extraction from a Solution Containing Disrupted Cells

An experiment of collecting a specific protein from a solution containing disrupted cells was conducted using a biosensor prepared with a combination of a measurement surface with the flow channel of the present invention and a flow channel prepared with a combination of a measurement surface with an untreated flow channel.

(5) Analysis of Proteins Extracted from the Solution Containing Disrupted Cells

Each flow channel was filled with HBS-P buffer. With this condition, 100 μl of an analyte solution was injected into the flow channel within 1 second and then the flow channel was allowed to stand for 3 minutes. Next, 100 μl of HBS-P buffer was injected into the flow channel within 1 second and then the flow channel was filled with a 50 mM NaOH aqueous solution. The flow channel was allowed to stand for 180 seconds and then the NaOH aqueous solution in the flow channel was collected. The thus collected solution was subjected to SDS-PEGE by the same technique as those of Example 2, silver staining was performed, and then the gel was observed. The results are listed in Table 2.

TABLE 2
Extraction of specific proteins with the use of various films

| | IgM | Actin | Keratin |
|---|---|---|---|
| Entire surface is coated | A | A | C |
| with SAM | | | |
| Only the detection plane | B | B | B |
| is coated with SAM | | | |
| Only the detection plane | C | B | B |
| is coated with CM5 | | | |

A: Easily and visually detectable within 30 seconds in the silver staining procedure (developing).
B: Visually detectable within 5 minutes in the silver staining procedure (developing).
C: Impossible to detect any significant differences compared with the background even at 5 minutes or more after the silver staining procedure (developing).

(6) Evaluation of the Results

As with the results in Table 2, it was demonstrated that the flow channel of the present invention, the surface of which had been entirely coated with SAM, has high capability for suppressing nonspecific adsorption of a protein such as keratin, compared with the comparative example. It was also demonstrated that the flow channel of the present invention has high capability for extracting target proteins. Thus, according to the present invention, a biosensor having excellent capability for extracting specific proteins could be provided.

### EFFECTS OF THE INVENTION

According to the present invention, nonspecific adsorption to the sensor surface and the flow channel surface, which can cause noise, is suppressed. This makes it possible to provide a biosensor having high capability for extracting a test substance that specifically interacts with a physiologically active substance.

1. A biosensor which comprises a flow channel that is formed on a substrate and is composed of a detection plane for detecting interaction between a physiologically active substance and a test substance and a non-detection plane where said interaction is not detected, wherein the substrate is a metal surface or a metal film and the surfaces of the detection plane and the non-detection plane are modified with a self-assembled monolayer (SAM) having a hydroxy group and a functional group for binding with a physiologically active substance.

2. The biosensor according to claim 1, wherein the self-assembled monolayer (SAM) having a hydroxy group and a functional group for binding with a physiologically active substance is composed of a mixture of a thiol compound having a hydroxy group and a thiol compound having a functional group for binding with a physiologically active substance.

3. The biosensor according to claim 1, wherein the functional group for binding with a physiologically active substance is a carboxyl group or an amino group.

4. The biosensor according to claim 1, which further comprises a mechanism for collecting a substance that interacts with a physiologically active substance.

5. The biosensor according to claim 1, wherein the metal surface or the metal film comprises a free electron metal selected from the group consisting of gold, silver, copper, platinum, and aluminium.

6. The biosensor according to claim 1, which is used for non-electrochemical detection.

7. The biosensor according to claim 1, which is used for surface plasmon resonance analysis.

8. A method for producing the biosensor according to claim 1, which comprises a step of modifying the surfaces of the detection plane and the non-detection plane of the flow channel with a self-assembled monolayer (SAM) having a hydroxy group and a functional group capable of binding with a physiologically active substance.

9. The method according to claim 8, wherein the self-assembled monolayer (SAM) having a hydroxy group and a functional group for binding with a physiologically active substance is composed of a mixture of a thiol compound having a hydroxy group and a thiol compound having a functional group for binding with a physiologically active substance.

10. The method according to claim 8, wherein the functional group for binding with a physiologically active substance is a carboxyl group or an amino group.

11. A method for detecting or measuring a substance that interacts with a physiologically active substance, which comprises steps of: causing the biosensor according to claim 1 to come into contact with a physiologically active substance, so as to covalently bind the physiologically active substance to the surfaces of a detection plane and a non-detection plane of the flow channel of the biosensor; and causing a test substance to come into contact with the biosensor wherein the physiologically active substance is covalently bound to the surfaces of the detection plane and the non-detection plane of the flow channel.

12. A method for producing a biosensor and detecting or measuring a substance that interacts with a physiologically active substance, wherein the following steps are continuously performed with one apparatus: a step of performing the method according to claim 8; a step of causing the biosensor produced in said step to come into contact with a physiologically active substance, so as to covalently bind the physiologically active substance to the surfaces of a detection plane and a non-detection plane of a flow channel of the biosensor; and a step of causing a test substance to come into contact with the biosensor wherein the physiologically active substance is covalently bound to the surfaces of the detection plane and the non-detection plane of the flow channel.

13. The method according to claim 11, wherein the step of binding the physiologically active substance to the biosensor and the step of causing the test substance to come into contact with the biosensor so as to detect or measure a substance that interacts with the physiologically active substance are performed using different apparatuses.

14. The method according to claim 11, wherein a substance that interacts with a physiologically active substance is detected or measured by a non-electrochemical method.

15. The method according to claim 11, wherein a substance that interacts with a physiologically active substance is detected or measured by surface plasmon resonance analysis.

16. A method for analyzing a substance that interacts with a physiologically active substance, which comprises detecting and collecting a substance that interacts with a physiologically active substance with the use of the biosensor according to claim 1 and determining the mass number of the collected substance using a mass spectrometer.
